(19) United States
(12) Patent Application Publication
(10) Pub. No.: US 2019/0251604 A1
(43) Pub. Date: Aug. 15, 2019

(54) PREDICTING AFTER-REHAB VALUE OF A REAL-ESTATE PROPERTY BASED ON REHAB-PACKAGES

(71) Applicant: Stoa Fund Ltd., Tel Aviv (IL)

(72) Inventors: Or AGASSI, Tel Aviv (IL); Tom SELLA, Miami, FL (US); Jonathan SARAGOSSI, Tel Aviv (IL)

(73) Assignee: Stoa Fund Ltd., Tel Aviv (IL)

(21) Appl. No.: 16/277,279

(22) Filed: Feb. 15, 2019

Related U.S. Application Data
(60) Provisional application No. 62/630,838, filed on Feb. 15, 2018.

(51) Int. Cl. G06Q 30/02; G06Q 50/16; G06Q 10/06

(52) U.S. Cl. CPC G06Q 30/0278; G06Q 10/06375; G06Q 50/165

(57) ABSTRACT

A system determines after rehab value (ARV) of a real-estate property (REP) based on a plurality of parameters associated with the asset and a projected rehab package. The determination comprises extraction of a plurality of structured parameters associated with the REP. The system then identifies a plurality of environmental variables associated with the REP. Thereafter, the system generates a weight to each identified parameter. Then, respective of the environmental variables, the structured parameters and the rehab package, the system generates an ARV of the REP.

### CROSS-REFERENCE TO RELATED APPLICATIONS

This application claims the benefit of U.S. Provisional Application No. 62/630,838 filed on Feb. 15, 2018 the contents of which are hereby incorporated by reference.

### TECHNICAL FIELD

The present disclosure relates generally to real-estate assessment tools, and more specifically to a system and methods for automatically evaluating a future value of a real-estate property respective of a certain rehab package.

### BACKGROUND

Even though advances in technology has become available in most industrial areas, the real-estate domain remains dependent on massive use of manual labor to perform tedious and costly tasks.

House flipping is a type of real estate investment strategy in which investors purchase properties with the goal of reselling them for a profit. Profit is generated either through the price appreciation that occurs as a result of a hot housing market and/or from developments and capital improvements to the property. Investors who employ these strategies face the risk of price depreciation in bad housing markets.

Investors who flip houses expect to generate a relatively high return on houses purchased, but may encounter cash-flow difficulties due to the nature of such strategies. Therefore, one of the most important issues facing the housing market, to date, is the inability to obtain an accurate projection of the after rehab value, or after repair value, (ARV) of the property. The ARV is defined as a value of property after renovations and repairs have been completed. Rehab is the process of increasing a value of a property through renovation.

Throughout the rehab, the investor faces challenges related to materials, labor, appliances, measurements, and other factors related to the rehab. Since each property has its own characteristics, determination of such factors should be performed for each property individually.

Further, a contractor can provide a cost estimate for the rehab, but cannot determine or predict after-rehab value. This value is not only determined by the quality of the rehab, but on also by the real east market in a certain location, and the property parameters. Thus, investors attempting to flip a property cannot determine at a glance as whether or not it is worth to invest in a property.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for predicting an after-rehab value (ARV) of a real-estate property based on a plurality of rehab packages, comprising: receiving a location pointer associated with at least one real-estate property; extracting metadata associated with the at least one real-estate property from at least one web source; determining similar rehab packages based in part on the extracted metadata; and computing a predicated ARV of the at least one real-estate property based on the metadata and the similar rehab packages.

Certain embodiments disclosed herein also include a non-transitory computer readable medium having stored thereon instructions for causing the server to execute a method for predicting an after-rehab value (ARV) of a real-estate property based on a plurality of rehab packages, comprising: receiving a location pointer associated with at least one real-estate property; extracting metadata associated with the at least one real-estate property from at least one web source; determining similar rehab packages based in part on the extracted metadata; and computing a predicated ARV of the at least one real-estate property based on the metadata and the similar rehab packages.

Certain embodiments disclosed herein also include a system for predicting an after-rehab value (ARV) of a real-estate property based on a plurality of rehab packages, comprising: a processing circuitry; and a memory, the memory containing instructions that, when executed by the processing circuitry, configure the system to: receive a location pointer associated with at least one real-estate property; extract metadata associated with the at least one real-estate property from at least one web source; determine similar rehab packages based in part on the extracted metadata; and compute a predicated ARV of the at least one real-estate property based on the metadata and the similar rehab packages.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosure will be apparent from the following detailed description taken in conjunction with the accompanying drawings.

FIG. 1 is a network diagram utilized to describe the various embodiment for predicting after-rehab value of a real-estate property according to an embodiment.

FIG. 2 is a flowchart describing a method for projecting an after-rehab value of a real-estate property based on a rehab-package according to an embodiment.

FIG. 3 is a flowchart describing a method for computing an ARV of a real-estate property according to an embodiment.

FIG. 4 is a block diagram of a system for predicting after-rehab value projection of a real-estate property according to an embodiment.

### DETAILED DESCRIPTION

It is important to note that the embodiments disclosed herein are only examples of the many advantageous uses of the teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Some example embodiments disclosed herein include a system and method for predicting an after-rehab value (ARV) of a real-estate property (REP), based on at least a rehab package. The determination includes extraction of a plurality of structured parameters associated with the real-estate property. The system is further configured to identify a plurality of environmental variables associated with the real-estate property. Thereafter, the system is configured to generate a weight for each identified parameter. At the final state the system outputs the environmental variables, the structured parameters and the rehab package, and generates an after-rehab value of the REP.

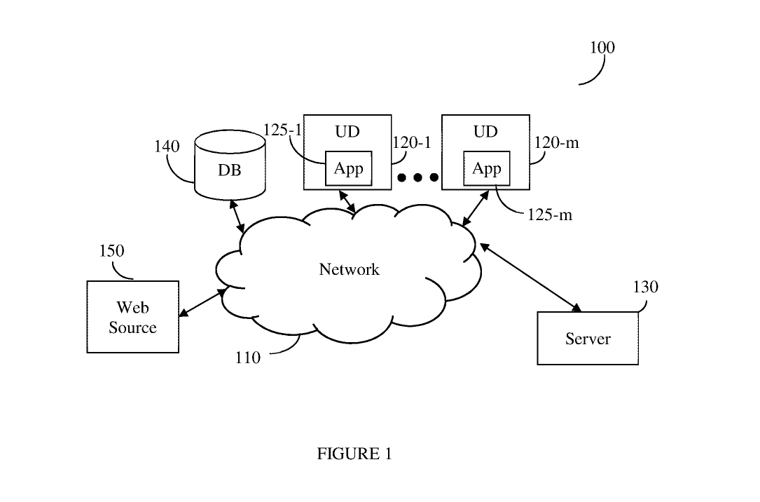

FIG. 1 is an example network diagram 100 utilized to project an after-rehab value according to an embodiment. As illustrated in FIG. 1, a network 110 may be the Internet, the world-wide-web (WWW), a local area network (LAN), a wide area network (WAN), a metro area network (MAN), and other networks capable of enabling communication between the elements of the system 100.

Optionally, one or more user devices 120-1 through 120-m, where m is an integer equal to or greater than 1, hereinafter referred to as user device 120 for simplicity, are further connected to the network 110. A user device 120 may be, for example, a personal computer (PC), a personal digital assistant (PDA), a mobile phone, a smart phone, a tablet computer, an electronic wearable device (e.g., glasses, a watch, etc.) and other kinds of wired and mobile appliances, equipped with browsing, viewing, capturing, storing, listening, filtering, and managing capabilities enabled as further discussed herein below.

Each user device 120 may further include a software application (App) 125 installed thereon. The software application 125 may be downloaded from an application repository, such as the Apple AppStore®, Google Play®, or any repositories hosting software applications. The application 125 may be pre-installed on the user device 120. In one embodiment, the application 125 is a web-browser.

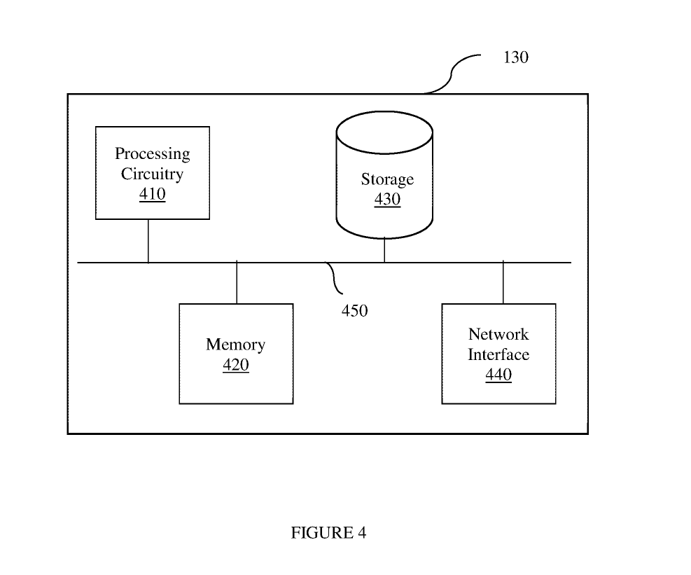

A server 130 is connected, over the network 110, to each user device 120 and can communicate therewith using the application 125 via the network 110. In an embodiment, the server 130 may be a physical device as illustrated in FIG. 4. In another embodiment, the server 130 may be virtual machine operable in a cloud computing platform. It should be noted that only one server 130 and one application 125 are discussed herein merely for the sake of simplicity. However, the embodiments disclosed herein are applicable to a plurality of user devices that can communicate with the server 130 via the network 110.

Also communicatively connected to the network 110 is a database 140 that stores metadata related to certain property transactions, data extracted from regulatory data sources and/or tax authorities, geographic information systems (GISs) home appliances' retailers, and more. In the embodiment illustrated in FIG. 1, the server 130 communicatively communicates with the database 140 through the network 110.

According to an embodiment, the server 130 is configured to receive at least one location pointer associated with at least one real-estate property. The location pointer may be received from a user device 120, via for example, the agent 125. The location pointer may be, for example, an address or a portion thereof, a geo-location, and the like.

Thereafter, the server 130 is further configured to extract metadata associated with the at least one real-estate property from at least one web source 150 over the network 110. The web source 150 may include, for example, governmental websites via the network, real-estate comparison websites (e.g., Zillow®), and the like. The metadata may include, for example, parameters associated with prior transactions made with respect to other real-estate properties determined to be associated to the at least one REP, one or more second REPs in proximity to the at least one REP, previous transactions made with respect to the at least one REP, data regarding rehab made with respect to the REP, and so on.

One or more second REPs may be determined as associated with the at least one REP based on metadata such as for example, year built, number of rooms and/or bathrooms, size e.g., square feet, demographic data, crime rate, proximity to certain venues, weather, and so on.

According to an embodiment, the server 130 is further configured to extract at least one multimedia content element associated with the at least one REP. The multimedia content element may be an overhead image of the location. The multimedia content element may be at least one image of a map associated with the REP. Such images may come from sources such as Google® maps, and similar sources.

In an embodiment, the database 140 is configured to store a plurality of earth map images. Thereafter, a surface outline of a surface, e.g., a rooftop, of the REP is identified. A pattern associated with the outlined surface is then determined by the server 130. The pattern may be recognized using machine learning techniques, image procession techniques, and the like.

Based on the multimedia content element, the server 130 is configured to identify venues located in proximity to the REP. The venues may include, for example, commercial venues, community venues, and so on. The server 130 is further configured to determine the distance between such venues and the REP.

The server 130 is further configured to identify a subdivision in which the REP is located. According to an embodiment, the server 130 is further configured to determine at least one view characteristic from the at least one REP respective of the multimedia content element as well as size parameters, e.g. square feet associated with the REP.

The server 130 is further configured to receive a rehab package (or estimation) as an input. The rehab package includes a specification of one or more repairs, replacements, renovations, etc. to be performed on the real estate property. The rehab package may further include rehab materials data, labor data, and the like. As an example, a rehab package may include replacement of 100 square feet of carpet, purchase of a new range, and/or cleaning of three windows. Price data associated with each item may be extracted from the database 140.

Then, the server 130 is configured to match the rehab package to a rehab made in the one or more second real estate properties, to which the rehab and the ARV is known. Based on the matching, the server 130 is configured to determine an evaluation of the ARV of the at least one real estate property.

According to a further embodiment, the server 130 is further configured to provide a recommendation of the required rehab in order to optimize the ARV of the real estate property. The recommendation is provided respective of the analysis of a plurality of rehabs made in many other real estate properties associated with the real estate property being considered and the ARV increase achieved respective thereof. As an example, in case an exterior paint job demonstrates high return on investment in real estate properties in proximity to the real estate property under consideration, a recommendation to perform an exterior paint job may be provided.

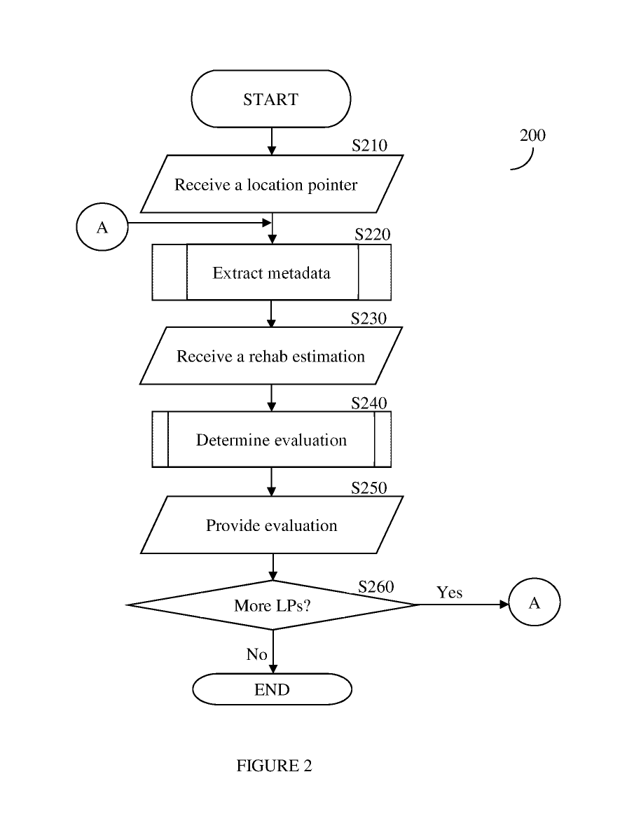

FIG. 2 shows an example flowchart 200 describing a method for predicting ARV of a real-estate property according to an embodiment. In an embodiment, the method is performed by the server 130 based on information received from at least one web source.

At S210, at least one location pointer associated with a REP under consideration is received, e.g., from a user device, such as the user device 120-1. The location pointer may be, for example, a physical address, a geo-location coordinates, and the like. The real estate property under consideration is a property being considered for an investment.

At S220, metadata associated with the property under consideration is identified. The metadata may include at least one of: parameters associated with previous transactions made with respect to one or more second properties in proximity to the at least one property, previous transactions made with respect to the at least one property, and so on. The metadata may be extracted from, for example, external web sources, such as governmental websites via the network 110, real-estate comparison websites, such as, for example, Zillow®, a combination thereof, and so on.

According to an embodiment, S220 may further include extraction of at least one multimedia content element associated with the property under consideration. The multimedia content element may be an overhead image of the location. The multimedia content element may be at least one image of a map associated with the property. Such images may come from sources such as Google® maps and similar sources.

In an embodiment, the database 140 is configured to store a plurality of earth map images. Thereafter, a surface outline of a surface, e.g., a rooftop of the REP is identified. A pattern associated with the outlined surface is then determined by the server 130.

S220 may further include identification of venues in proximity to the REP. The venues may include, for example, commercial venues, community venues, etc. The server 130 is further configured to determine the proximity of the venues to the REP.

Optionally, at S220, a subdivision's location real estate property is identified. To this end, characteristics from the at least one REP respective of the multimedia content element as well as size parameters, e.g., square feet associated with the property, are determined.

At S230, a rehab package is received. The rehab package includes a specification of one or more repairs, replacements, renovations, etc., to be performed in the real estate property. The rehab packages may further include rehab materials data, labor data, and so on, as well as an estimation of the rehab cost.

At S240, an after-rehab value (ARV) of the real estate property is determined. In an embodiment, a weighted decision algorithm is utilized to compute the after-rehab value of the real estate property. Accordingly, each parameter collected with respect to the real estate property is assigned with a virtual value indicating the importance of the respective parameter to the evaluation.

As an example, data collected from a tax bureau indicating the current transaction made with respect to the real estate property may receive a higher virtual value than the view characteristics and therefore will be more significant in the determination of ARV. In one embodiment, the weighted decision algorithm computes the ARV, for example, as an average sum of the virtual values.

The computation of virtual values of the parameters collected may be adjusted based on the total amount of data collected. For example, if only a few elements are collected, then each such collected element will be more significant in the evaluation determination. In one embodiment, the virtual values are computed using rules stored in a database 140. Each such rule sets the value for each piece of data collected for the evaluation.

At optional S250, the ARV is provided as an output to, for example, a user device. At S260, it is checked if additional location pointers have been received, and if so, execution continues with S220; otherwise, execution terminates.

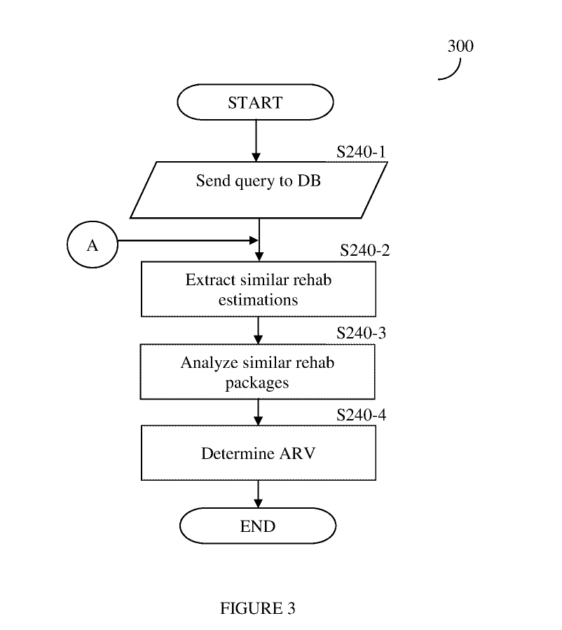

FIG. 3 depicts an example flowchart S240 describing the step for determining an ARV of a real estate property according to an embodiment. At S240-1, the operation starts when at least one query is sent to the database 140. The query comprises metadata associated with the real estate property and/or portions thereof, and metadata associated with the rehab package.

At S240-2, similar rehab packages are extracted in response to the query. At S240-3, the similar rehab packages are analyzed. At S240-4, a potential ARV is determined based on the analysis and execution is terminated. Specifically, similar rehab packages are compared to the property under consideration. As the costs of items included in the rehab package are known, the pre-rehab and post-rehab values can be analyzed to determine the increase in value with respect to each rehab package.

For example, a first pre-rehab property in Aventura, Miami Fla. was purchased for $100,000. Then, a rehab that includes a marble counter purchase, a carpet removal and paint job of 1,700 square feet was conducted. The rehab costs were $10,000. The after-rehab property was later sold for $150,000. Therefore, the contribution of the rehab to the ARV was $40,000.

A second pre-rehab property in Aventura, Miami Fla. was bought for $100,000. Then a rehab that included a wood counter purchase, a carpet removal and paint job of 1,700 square feet was conducted. The rehab costs were $10,000. The after-rehab property was sold at the same time as the first property for $140,000. Therefore, the contribution of the rehab to the ARV was $30,000. Hence, the rehab contribution to the ARV for each case and the return of investment for each rehab item can be determined.

FIG. 4 is an example schematic diagram of a server 130 according to an embodiment. The server 130 includes a processing circuitry 410 coupled to a memory 420, a storage 430, and a network interface 440. In an embodiment, the components of the server 130 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), GPUs, general-purpose microprocessors, microcontrollers, digital signal processors (DSPs), and the like, or any other hardware logic components that can perform calculations or other manipulations of information.

The memory 420 may be volatile (e.g., RAM, etc.), non-volatile (e.g., ROM, flash memory, etc.), or a combination thereof. In one configuration, computer readable instructions to implement one or more embodiments disclosed herein may be stored in the storage 430.

In another embodiment, the memory 420 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein. Specifically, the instructions, when executed, cause the processing circuitry 410 to predict ARV of a real-estate property as discussed herein.

The storage 430 may be magnetic storage, optical storage, and the like, and may be realized, for example, as flash memory or other memory technology, CD-ROM, Digital Versatile Disks (DVDs), or any other medium which can be used to store the desired information.

The network interface 440 allows the server 130 to communicate with the user devices, web sources and data warehouse (shown in FIG. 1).

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for predicting an after-rehab value (ARV) of a real-estate property based on a plurality of rehab packages, comprising:
receiving a location pointer associated with at least one real-estate property;
extracting metadata associated with the at least one real-estate property from at least one web source;
determining similar rehab packages based in part on the extracted metadata; and
computing a predicated ARV of the at least one real-estate property based on the metadata and the similar rehab packages.

2. The method of claim 1, wherein each rehab package includes at least one of: a rehab budget and at least one rehab item.

3. The method of claim 2, wherein the at least one rehab item is at least one of: size parameters associated with the at least one real-estate property, labor cost, material types, material costs, appliance types, and appliance costs.

4. The method of claim 1, further comprising:
retrieving from similar rehab packages based on the extracted metadata.

5. The method of claim 1, wherein the web source is any one of: a governmental website and a real-estate comparison website.

6. The method of claim 1, wherein the metadata may include parameters associated with prior transactions made with respect to: other real-estate properties (REPs) determined to be associated to the real estate property, one or more second REPs in proximity to the at least one real estate property, previous transaction made with respect to the real estate property, and data regarding rehabs made with respect to the real estate property.

7. A non-transitory computer readable medium having stored thereon instructions for causing the server to execute a method for predicting an after-rehab value (ARV) of a real-estate property based on a plurality of rehab packages, comprising:
receiving a location pointer associated with at least one real-estate property;
extracting metadata associated with the at least one real-estate property from at least one web source;
determining similar rehab packages based in part on the extracted metadata; and computing a predicated ARV of the at least one real-estate property based on the metadata and the similar rehab packages.

8. A system for predicting an after-rehab value (ARV) of a real-estate property based on a plurality of rehab packages, comprising:
a processing circuitry; and
a memory, the memory containing instructions that, when executed by the processing circuitry, configure the system to:
receive a location pointer associated with at least one real-estate property;
extract metadata associated with the at least one real-estate property from at least one web source;
determine similar rehab packages based in part on the extracted metadata; and
compute a predicated ARV of the at least one real-estate property based on the metadata and the similar rehab packages.

9. The system of claim 8, wherein each rehab package includes at least one of: a rehab budget and at least one rehab item.

10. The system of claim 9, wherein the at least one rehab item is at least one of: size parameters associated with the at least one real-estate property, labor cost, material types, material costs, appliance types, and appliance costs.

11. The system of claim 8, wherein the system if further configured to:
retrieve from similar rehab packages based on the extracted metadata.

12. The system of claim 8, wherein the web source is any one of: a governmental website and a real-estate comparison website.

13. The system of claim 8, wherein the metadata may include parameters associated with prior transactions made with respect to: other real-estate properties (REPs) determined to be associated to the real estate property, one or more second REPs in proximity to the at least one real estate property, previous transaction made with respect to the real estate property, and data regarding rehabs made with respect to the real estate property.
